(19) United States
(12) Patent Application Publication
(10) Pub. No.: US 2001/0047340 A1
(43) Pub. Date: Nov. 29, 2001

(54) Authenticity verification method and apparatus

(76) Inventors: Donnie Snow, Sydney (CA); Mike Hayes, Sydney (CA); John Hussey, Sydney (CA); Mark Klaamas, Sydney (CA); Kevin Bechard, Sydney (CA); Mark Bishoff, Sydney (CA)

Correspondence Address: MARKS & CLERK, Suite 280, 280 Slater Street, Ottawa, ON, K1P 1C2, CA

(21) Appl. No.: 09/767,849

(22) Filed: Jan. 24, 2001

Related U.S. Application Data
(60) Provisional application No. 60/177,672, filed on Jan. 27, 2000.

(51) Int. Cl. G06F 17/60

(52) U.S. Cl. 705/58

(57) ABSTRACT

A method and apparatus for insuring authenticity for consumer goods as well as products transferred to another party. In one embodiment, a record of authenticity is provided with a good at the point of manufacture. The record of authenticity includes an item code and a registration number unique to the good. An internet database stores the authenticity data. Once an article or good is purchased, the owner of the article accesses the database and is forwarded a second registration number which is different from the initial registration number provided at the point of manufacture. The owner may register as a legitimate owner of authentic goods by entering the new registration number and item code as well as other information. This information is stored in the internet database for the good in issue. The system also provides for insuring that any good transferred in title to a second party is an authentic article and also lists information for this party relative to the article.

### FIELD OF THE INVENTION

The present invention relates a system and a method for ensuring authenticity of consumer goods as well as products sold second hand to another party. More particularly, the present invention provides an internet-based authenticity verification protocol and system.

### BACKGROUND OF THE INVENTION

In view of the booming e-commerce that has developed on the internet, product authenticity and seller reliability issues have taken on paramount importance. It has been reported that there is clearly a need for improved security measures to protect consumers involved in on-line transactions.

As is known in the e-commerce field, illegal counterfeiting of products is one of the fastest growing industries in today's global marketplace. The worldwide counterfeit market is worth approximately 250 billion dollars with the on-line portion estimated to be in the neighborhood of 10% of this total.

Part of the appeal of counterfeiting on the internet is achieved through a possibility of reaching millions of potential victims, via professional looking websites that appear to reflect legitimate business operations. Traditionally, consumers have had the benefit of a fixed storefront complete with staff, management inter alia. In the e-commerce world, all of the conventional attributes of a legitimate business are no longer required; a simple website can be created which has the presentation of a professional organization which, in reality, is simply a guise for an illegitimate venture.

One of the favored areas for pillage is in the area of sports collectibles and autographed memorabilia. It has been stated previously that roughly 60% of fans and collectors pay for fake autographed sports memorabilia. Reputable suppliers of such memorabilia lose millions in potential revenue to unscrupulous and dishonest sellers. Athletes, agents and major league sports organizations are consistently denied potential revenue due to inadequate deterrence against fraud and trademark infringement. One of the reasons why this market is rife with fraudulent activity is due to the fact that unlike traditional collectibles like fine art and antiques, autographed sports memorabilia is an extremely easy item to reproduce. The only necessary requirement to produce fake merchandise is a marker and a copy of the athlete's signature. It has been estimated that the percentage of fakes currently in existence is in the neighborhood of between 60% and 70%. Depending on the marquis of the player, this number can even be higher.

Other areas where fraudulent activity, particularly over the internet, has been found is in the licensed products market, the branded luxury goods and designer merchandise and the art and antiquities market.

In the prior art there have been a number of patents which have issued directed to ensuring authenticity of various items such as an autograph or other articles. Exemplary of the art is U.S. Pat. No. 5,971,435, issued Oct. 26, 1999, to DiCesare. In this reference there is disclosed a method for ensuring authentication of an autograph. In the method described in the patent, an article autograph is witnessed and a voucher is issued which sets forth the details of the autographing and the signatures and identification of the witnesses as well as an identifying code number. This code number is affixed to the article and a certificate of authenticity bearing a further code number that is different from the code number of the article and voucher is provided. This contains a description of the article together with signing and witness details and owner details. A database is subsequently employed which contains the details of the signing and witnessing together with a record of the code numbers and identification of the owner of the article. The method and system set forth in this reference are useful, however, there are limitations in that no new registration number is issued upon further conveyances of the title of the autograph. Further, the registration number in the DiCesare system is not concealed and thus would permit unauthorized viewing or access to this number. Further, the system is inherently limited in that only a single code is provided. Although it is replaced with a different code, this system does not provide the necessary degree of control over the article and thus provide the necessary security for ensuring authenticity.

In the prior art there have been a number of patents which have issued directed to ensuring authenticity of various items such as an autograph or other articles. Exemplary of the art is U.S. Pat. No. 5,971,435, issued Oct. 26,1999, to DiCesare. In this reference there is disclosed a method for ensuring authentication of an autograph. In the method described in the patent, an article autograph is witnessed and a voucher is issued which sets forth the details of the autographing and the signatures and identification of the witnesses as well as an identifying code number. This code number is affixed to the article and a certificate of authenticity bearing a further code number that is different from the code number of the article and voucher is provided. This contains a description of the article together with signing and witness details and owner details. A database is subsequently employed which contains the details of the signing and witnessing together with a record of the code numbers and identification of the owner of the article. The method and system set forth in this reference are useful, however, there are limitations in that no new registration number is issued upon further conveyances of the title of the autograph. Further, the registration number in the DiCesare system is not concealed and thus would permit unauthorized viewing or access to this number. Further, the system is inherently limited in that only a single code is provided. Although it is replaced with a different code, this system does not provide the necessary degree of control over the article and thus provide the necessary security for ensuring authenticity.

Kruckemeyer, in U.S. Pat. No. 5,737,886, issued Apr. 14, 1998, provides a method for determining forgeries and authenticating signatures. In the method, signatures are placed on an object or document and a diffraction grading pattern is issued to the person whose signature is being protected by a central register. A personal number which has been assigned by the central register to the owner is encoded into the diffraction medium. The personal number remains constant and is encoded on all diffraction medium distributed to the principle in addition to the personal number, the diffraction medium contains a further code distinct for each diffraction medium distributed to the owner. The owner must acknowledge to the register through the use of the personal code number that it has received possession of the diffraction media before they are viewed as valid. As an item is transferred from one owner to a further owner, a record of the transfer is kept by the register which issues certificates of authenticity to all subsequent owners. Although a useful system, the system permits tampering in that diffraction medium can clearly be removed from an article and placed on another article which is a replica but not an authentic version of the article.

In U.S. Pat. No. 5,289,547, issued Feb. 22, 1994, to Ligas et al., an authenticating method is provided for articles where photochromic compounds are incorporated into a carrier to be positioned on an article. Apart from the fact that the material is placed on the article, there is no registration of the item or any other provision for ensuring authenticity when the item or article is transferred from one owner to another.

Del'olno, in U.S. Pat. No. 5,873,305, issued Feb. 23, 1999, provides a personalization method of pre-printed sheets using micro engravings.

Hoshino et al., in U.S. Pat. No. 5,739,517, issued Apr. 14, 1998, provides an apparatus and method for checking authenticity of an object where both magnetic and nonmagnetic materials are employed. A scanner is used to detect an appropriate signal relating to authentic articles. This involves the use of a scanning device together with magnetic pieces which must be provided on the article and accordingly, steps are involved to effect this application and costs are involved in providing a scanner to detect the appropriate signal.

In U.S. Pat. No. 5,497,227, issued Mar. 5, 1996, to Takeuchi, a system for determining authenticity of an object is disclosed where a hologram or other means of diffraction grading are applied to the article. Similar to U.S. Pat. No. 5,739,517, this disclosure relates to a modification of the article to be authenticated together with the use of a specific reader which would have no further utility other than that for reading the diffraction pattern.

With respect to internet-related patents, there are several which have issued recently. Inclusive of these is U.S. Pat. No. 6,055,513, issued Apr. 25, 2000 to Katz et al., U.S. Pat. No. 5,897,620, issued to Walker et al., Apr. 27, 1999, and U.S. Pat. No. 6,029,141, issued Feb. 22, 2000 to Bezos et al.

It would be desirable if there were a system and method where authenticity of, for example, manufactured goods could be confirmed at the point of manufacture and this authenticity ensured upon purchase of the article by a consumer. It would also be desirable if, upon subsequent transfer of the article to another owner, authenticity could be ensured by the monitoring of the transfer by another party without the possibility of tampering, forgery or otherwise degradation of the authenticity of the article. The present invention seeks to address these features and solve the problems which have eluded the methods and protocol presented in the prior art.

### SUMMARY OF THE INVENTION

One object of the present invention is to provide an improved protocol and system for ensuring authenticity of an article.

According to a further object of one embodiment of the present invention, there is provided an online method of confirming authenticity of a purchased good, comprising the steps of:

providing a record of authenticity with a good, the record of authenticity having authenticity data including an item code and an initial registration number unique to the good;

providing an internet accessible database having stored authenticity data for the good;

purchasing the good;

accessing the internet database;

forwarding a subsequent registration number different from the initial registration number;

registering an owner of the good purchased by entering the subsequent registration number, the item code and purchaser information; and

storing the information in the internet accessible database relative to the good purchased.

As one significant advantage, the methodology according to the present invention is internet-based and provides a verification protocol where consumers can easily verify the authenticity of goods purchased either through retailers or e-tailers. By providing a certificate, the consumer automatically realizes that the article is registered and that it is authentic. Further, by the protocol set forth herein, the authenticity of an item purchased can remain intact throughout the life of the item through subsequent transfers in title. This is in marked contrast to existing systems which simply track items to the point of retail sale. The existing systems, apart from provenance with antiquities, do not sufficiently address products that are resold numerous times throughout the life of the product. As such, collectors and consumers have had previously no means to confirm the validity of purchases made.

Conveniently, the system described herein permits the registration of multiple items and owners of valuable goods or collectors may register all of their items in the database thus allowing for tracking of the history and cost of each item.

A further object of one embodiment of the present invention is to provide a method for ensuring authenticity of an article purchased over the internet, comprising the steps of:

providing a website having a database where articles are registered by an owner;

providing a record of authenticity with the article to be registered, the record of authenticity having a registration number and an item number;

entering the registration number and the item number in the database relative to the article;

purchasing by a purchaser, the article and receiving the registration number and the item number;

accessing the database;

providing purchaser registration information to the database;

confidentially receiving a buyer registration number different from the purchaser registration number from the database; and

registering as a new owner of the article.

The protocol as set forth herein also provides advantages to, for example, the holders for intellectual property such as copyright and trademarks. In the system of the present invention, the originator of the work (musical composition, document book, etc.) can be provided with income from not only the initial sale of the item, but also through the chain of title that may subsequently result. In this manner, residual income is always provided to the originator through subsequent transfers of the article. Thus, a still further object of one embodiment of the present invention is to provide a method for providing an author/creator with compensation for its commodity having originality value from purchases and transfer of ownership of the commodity over the internet, comprising the steps of:

providing a record of authenticity with a commodity, the record of authenticity having authenticity data including a registration number and item code unique to the commodity;

providing an internet accessible database having stored authenticity data for the commodity;

purchasing the commodity;

accessing the internet database;

registering an owner of the commodity purchased by entering the registration number, the item code and purchaser information;

providing the author/creator with a predetermined percentage of a purchase price of the commodity;

transferring ownership of the commodity to a subsequent purchaser;

providing the subsequent purchaser with the item code;

accessing the database and entering the item code;

confidentially forwarding a subsequent registration number different from said registration number;

registering the subsequent purchaser as a new owner of the commodity; and

providing the author/creator with a second predetermined percentage of the purchase price paid by the subsequent purchaser.

In order to effect the method according to the present invention, as indicated above, the user would incorporate the internet together with a system for accessing a company registration database. According to a further object of one embodiment of the present invention there is provided an online system for confirming authenticity of a good purchased on the internet, comprising:

means for identifying a good as an original;

computer database means containing the means for identifying an article as an original;

an internet computer network linking potential purchaser computers with each other and the computer database means;

means for registering purchaser information for a purchased good;

means for confirming ownership of a purchased good to a registered purchaser; and

means for confirming authenticity of a subsequently sold article from the purchaser to a new purchaser.

Yet another object of one embodiment of the present invention is to provide a website for registering and confirming authenticity of an article, comprising:

means for confirming an article for registration as an authentic article;

means for registering an article;

means for registering a user;

means for registering an article with an owner;

means for registering an article description;

means for registering transfer of the article from an owner to a purchaser; and

means for registering the purchaser as a new owner of the authentic article.

Having thus generally described invention, reference will now be made to the accompanying drawings.

### BRIEF DESCRIPTION OF THE DRAWINGS

FIG. 1 is a schematic illustration of the authentication process for items;

FIG. 2 is a schematic illustration of the steps involved from ticket generation to item matching with a respective ticket;

FIG. 3 is a schematic illustration of the validation protocol;

FIG. 4 is a schematic illustration of the transfer of title and authentication protocol;

FIG. 5 is a schematic illustration of the database system for a use in the present invention;

FIG. 6A is a plan view of a certificate of authenticity associated with the present invention;

FIG. 6B is a further plan view of FIG. 6A;

FIG. 7A is a plan view of a certificate of authenticity associated with the present invention provided at the point of manufacture;

FIG. 7B is a plan view of FIG. 7A illustrating the registration number associated with an article;

FIG. 8 is a view of one page of the website according to the present invention;

FIG. 9 is a view of a page associated with the website of the present invention illustrating an article;

FIG. 10 is a further page of the website according to the present invention where an article is being transferred from one user to another; and

FIG. 11 is a further page associated with the website of the present invention where a collection list is set forth.

Similar numerals used in the drawings denote similar elements.

### DETAILED DESCRIPTION OF THE PREFERRED EMBODIMENTS

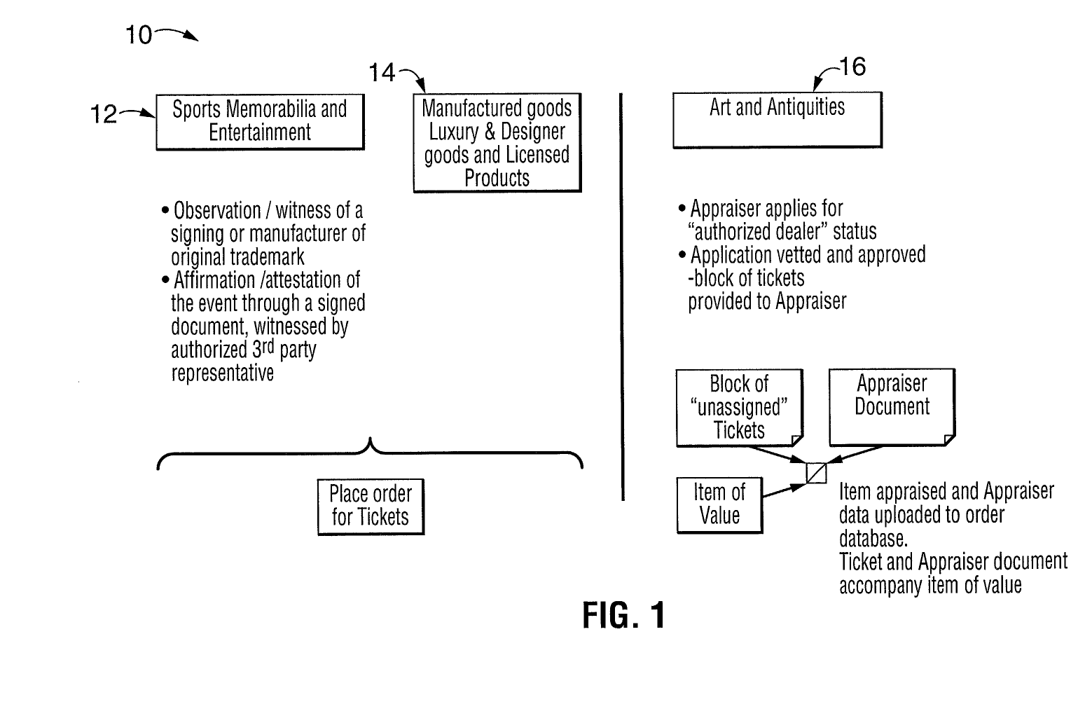

Referring now to FIG. 1, shown is overall authentication process according to one embodiment, with the process being broadly denoted by numeral 10.

An article, globally denoted by numeral 12, such as sports memorabilia, may be autographed by an athlete (the signature of athlete is not shown in FIG. 1). This is observed by a witness of the signing or, in the case of a manufactured good, by the manufacturer of the original trademarked good. As a further possibility, affirmation or attestation of the event may occur through a signed document witnessed by an authorized third party representative.

In the event that the article comprises manufactured goods such as luxury and designer goods or licensed products, globally denoted by numeral 14, the manufacturer would apply to a registration company for approval for participation in the authentication program. Either one of the examples 12 or 14 then apply to the registration company for tickets (not shown) and discussed in greater detail hereinafter.

I n the case where the article comprises art or antiquities, globally referenced by numeral 16, an appraiser would apply to the registration company for “authorized dealer” status. The registration company would approve release of a block of tickets to be provided to the appraiser. In this manner, the steps would involve assignment of a block of “unassigned” tickets from the registration company. Appraisal of the item and subsequent uploading of that data to the registration company database (the database is not shown in FIG. 1 and will be discussed in greater detail hereinafter). The registration company ticket and appraisal document are then associated with the item.

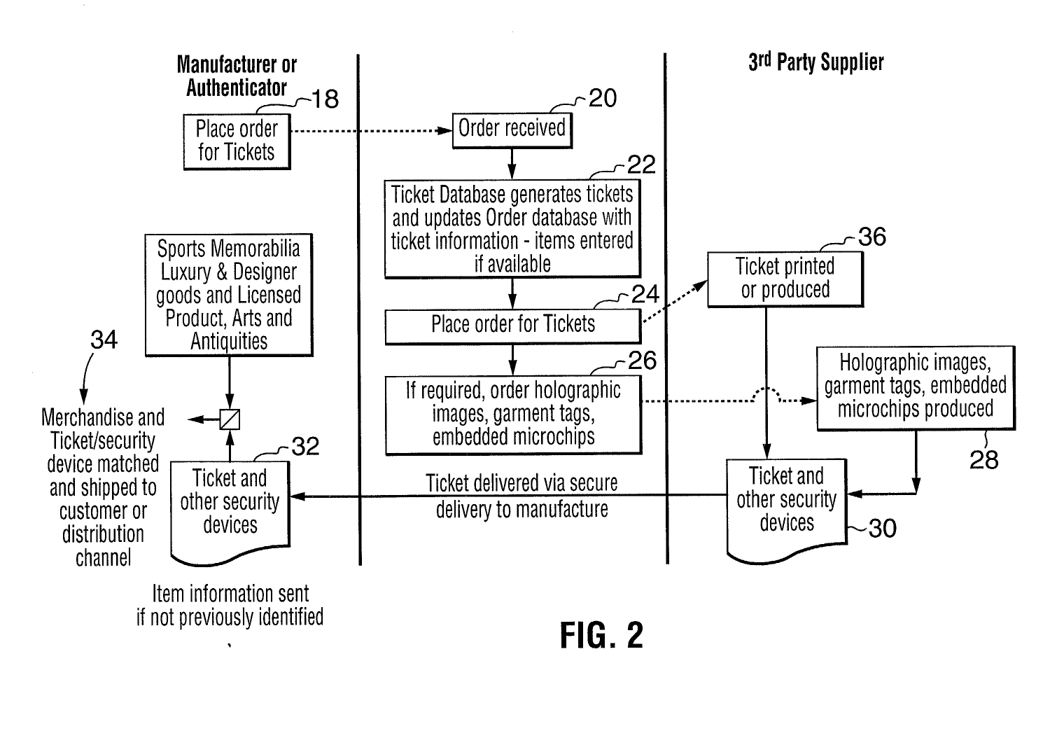

Referring to FIG. 2, shown as a schematic demonstration of the process involved in the generation and distribution tickets from the registration company. In the first stage, the manufacturer or authenticator places an order for tickets, this step being denoted by numeral 18. The order is then received by the registration company, this step being denoted by numeral 20. The registration company subsequently accesses its ticket database and updates an order database with ticket information and items entered. This step is denoted by numeral 22. The ticket order is then placed at 24 and if required, holographic images, garment tags, or embedded microchips are ordered. This step is denoted by numeral 26. The latter mentioned elements may be then produced at 28 and subsequently associated with the tickets and other security devices, this step being denoted by numeral 30. The tickets are then delivered via secure delivery to a manufacturer, this step denoted by numeral 32. The merchandise at the registration company and tickets or security devices are matched and shipped to the customer or to a suitable distribution channel, this step being denoted by numeral 34.

Returning to step 24, in the event that no ancillary security device is required, such as those exemplified in step 26, the tickets may be printed or produced at step 36 and subsequently processed through steps 30, 32 and 34.

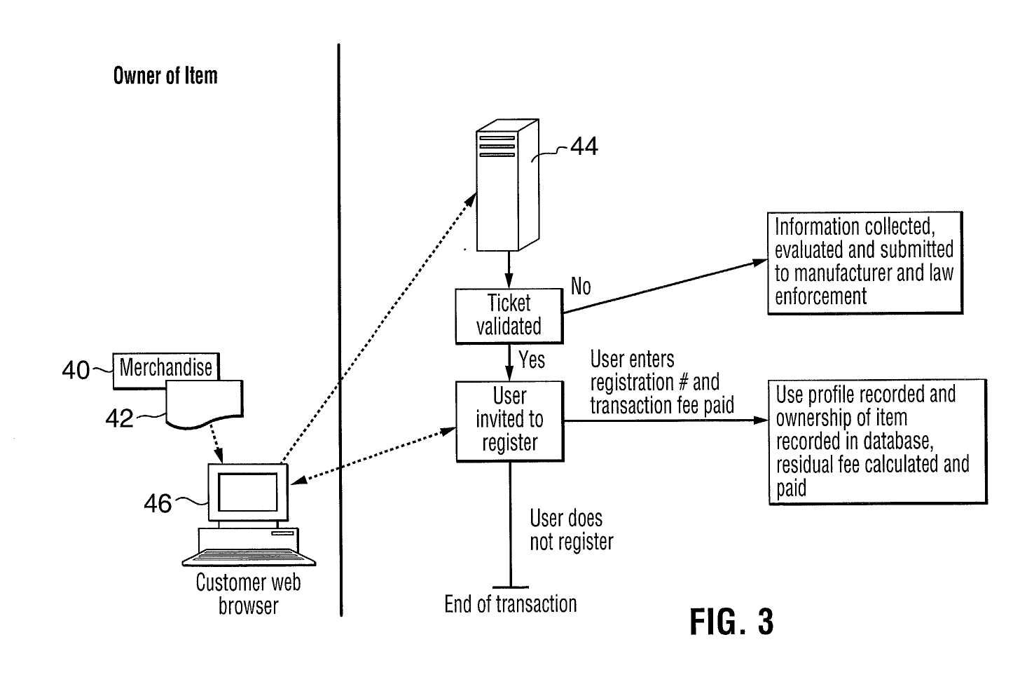

Turning now to FIG. 3, shown is schematic illustration of protocol for validation of an authenticated item.

The specific item of merchandise 40 and the registration company ticket 42 are matched and entered into the registration company's database 44 via its website. This is achieved by making use of a conventional computer 46 and using the customer's web browser. The information, namely the validation ticket, is validated by comparison with information in registration company's database 44 and if the information is deemed valid, the user is subsequently invited to register the item in the registration company's database 44. The user would enter a registration number (not shown and discussed hereinafter) which is associated with the ticket and would also pay a transaction fee. This would provide the user with a profile, an indication that it is the owner of the item, recordal of this information in database 44 and calculation of the fee.

As an alternative, the user has the option of not registering the item, at which point the transaction would cease.

One of the attractive benefits of this system is that failure to have a ticket validated results in necessary information being collected such as a user's name, e-mail address, description of the item which can be subsequently evaluated and submitted to manufacturer and law enforcement.

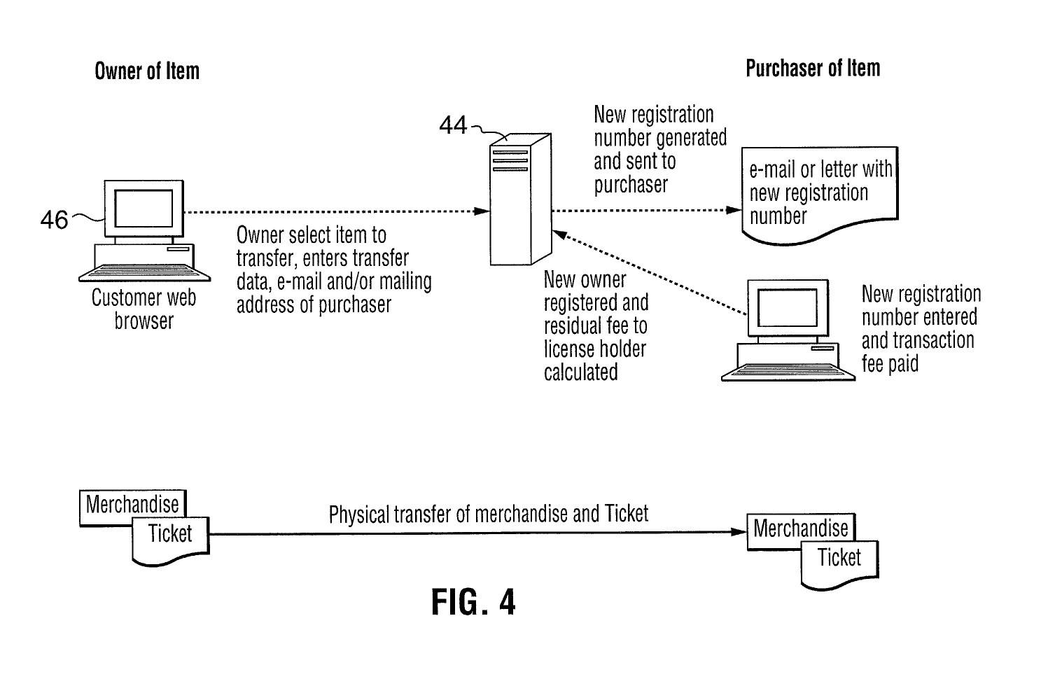

FIG. 4 schematically illustrates a transfer of title process according to one embodiment of the present invention. In the transfer system, the customer using its web browser on its computer 46, selects an item to transfer (sell to a purchaser) and enters the transfer data including the e-mail address and/or mailing address of the purchaser. This information is submitted to the registration company database 44 with a new registration number generated by the database 44 and forwarded to the purchaser. This registration number is conveyed to the new purchaser by any suitable means such as electronic mail, conventional mail, telephone or any other suitable telecommunication means. Once the registration number is received by the purchaser, the new registration number is entered into the database 44 and a transaction fee paid by the purchaser. Once the information has been recorded in the database 44, an optional step exists for providing residual fees (royalties) to a license holder or originator of the work. In this manner, the original author or creator of the article being transferred is compensated not only for the first purchase of the article but also for subsequent changes in title.

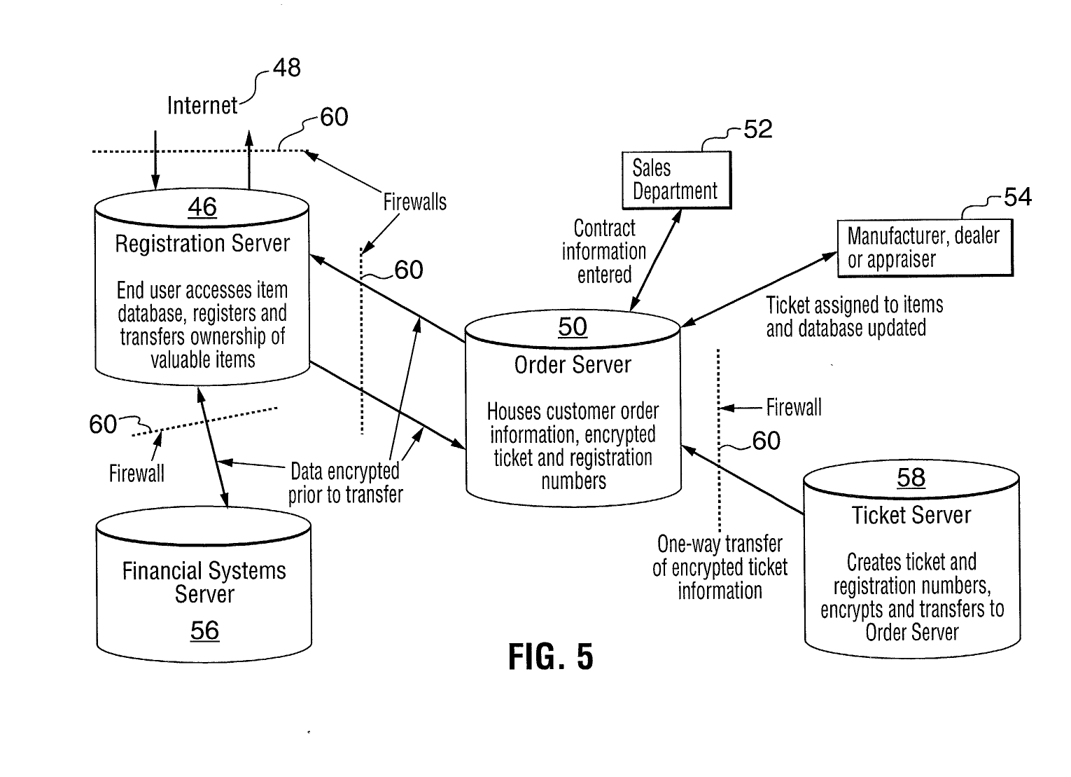

Regarding FIG. 5, the same schematically illustrates database scheme where a registration server 46 communicates with the internet, broadly denoted by numeral 48. The registration server 46 communicates with order server 50 which typically retains customer order information, encrypted ticket and registration numbers. Order server 50 in turn provides a communication between itself and other departments such as a sales department 52, manufacture dealer or appraiser 54. The financial systems server 56 also communicates with registration server 46. With respect to communication between all of the servers discussed thus far, communication is two-way. This is not true of the ticket server 58 which creates tickets, registration numbers and encrypts and transfers this information to the order server 50. Communication between ticket server 58 and order server 50 is monodirectional from the former to the latter. Firewalls 60 exist at all points of communication between the servers and, of course, between the registration server 46 and internet 48.

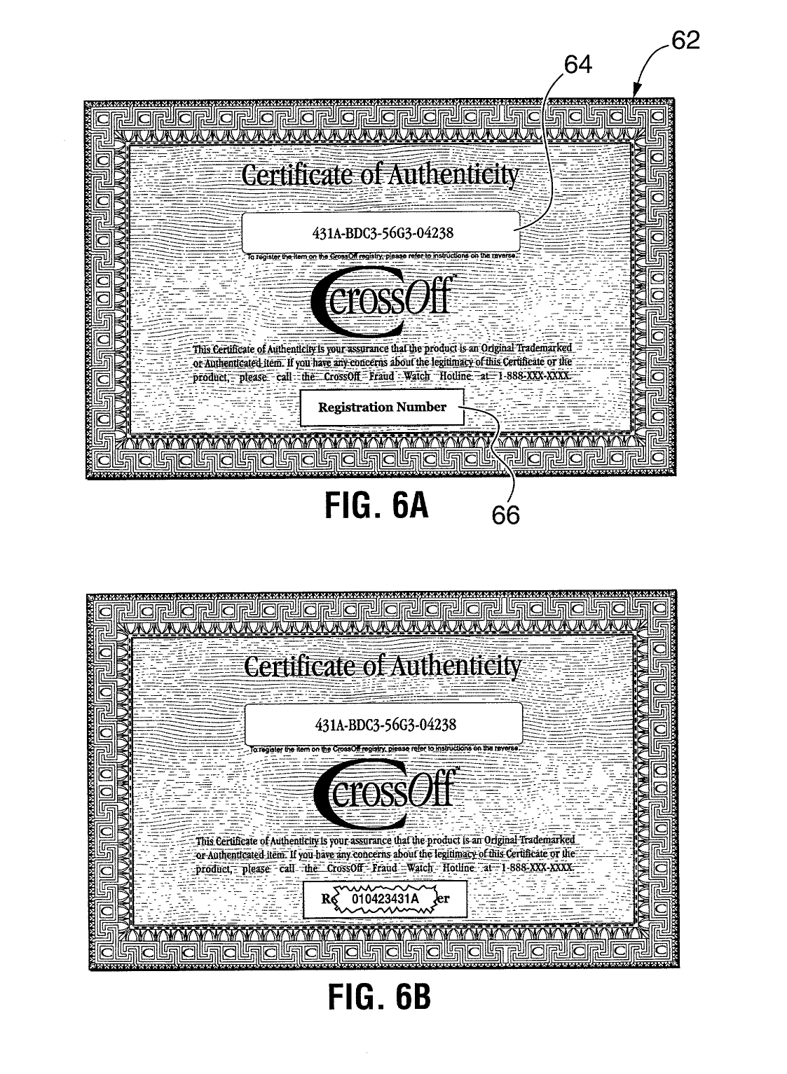

Turning to FIGS. 6A and 6B, shown in examples of a certificate of authenticity which can be provided from the manufacturer at the point of manufacture for a good. The certificate is broadly indicated by numeral 62 and includes a registration company number 64 and an ancillary number 66, indicated in the Figure as a registration number. Registration company number 64 is a specific numeral which is unique to the article registered. Registration number 66, is initially covered with a latex material which can be removed by the first purchaser of the article from manufacturer.

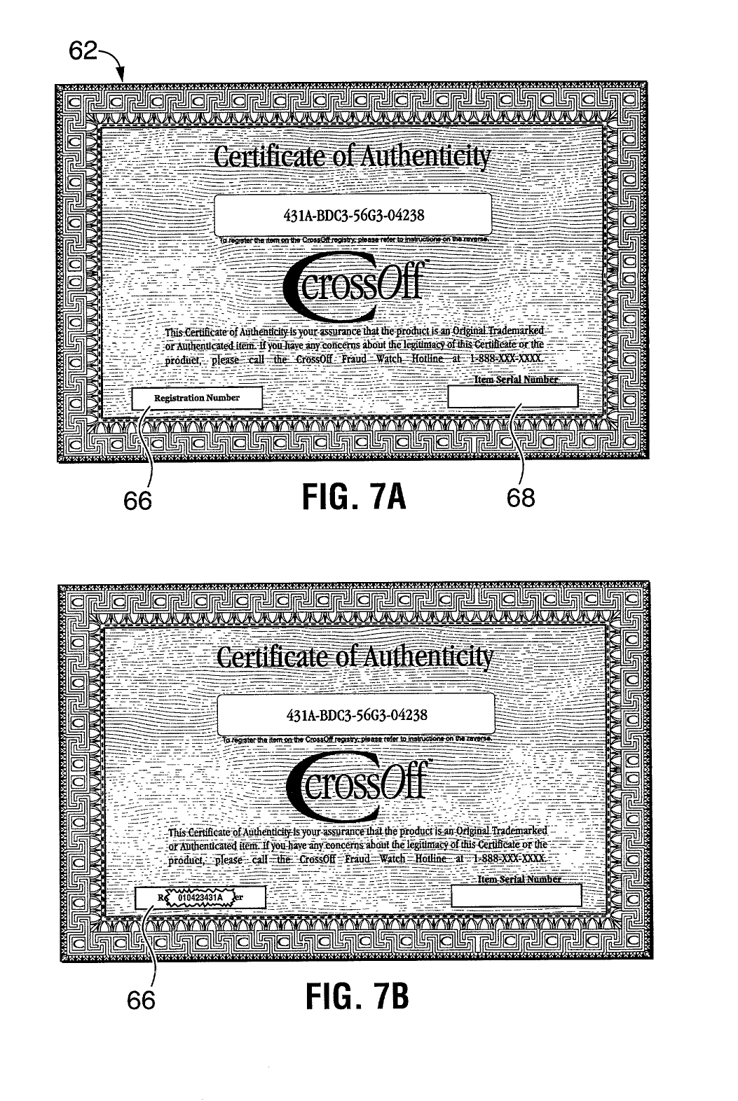

Turning to FIGS. 7A and 7B, shown are certificates 62 which are issued by the registration company to a subsequent purchaser. This certificate is sent to the new owner once registration has been effected and authenticity confirmed. In the certificate shown in FIG. 7A the registration number is covered with latex material and also includes, in the example, a serial number field 68. FIG. 7B illustrates the certificate with the latex material removed to reveal a registration number.

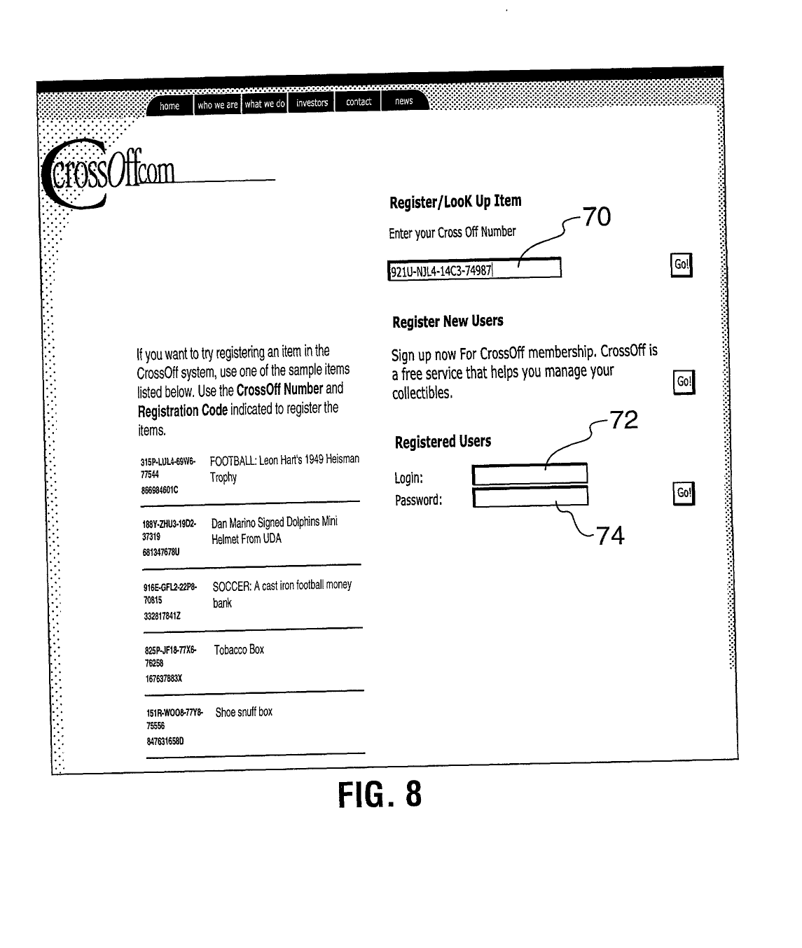

FIG. 8 illustrates one embodiment of the website where there is included a field 70 for entering the registration company number associated with an article as well as a field 72 for logging in as a registered user and a field 74 for entry of a password.

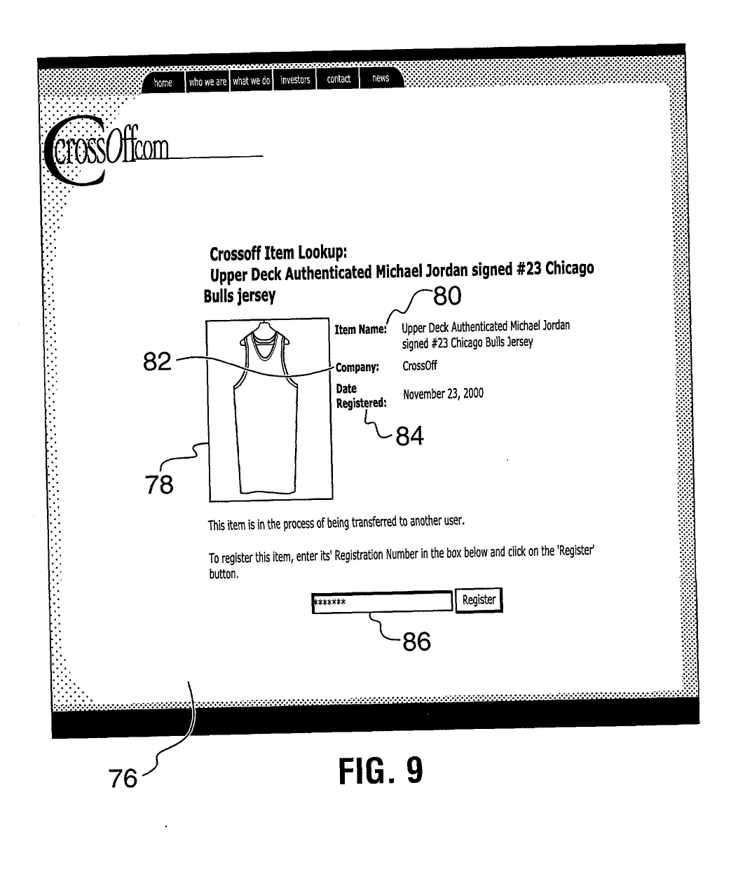

FIG. 9 illustrates a further page 76 associated with the website where a user can look up an item from entering the registration number in field 70 of FIG. 8. In the example, the item is basketball jersey 78 and there is included on this page 76 an item name field 80 which describes the article a company name field 82 which stipulates the company owning the article or an individual as well as a date registered field 84 which indicates the date that the article was registered with the registration company. Field 86 is a registration field where the registration number discussed herein previously is entered in order for a user to enter this as an authentic article.

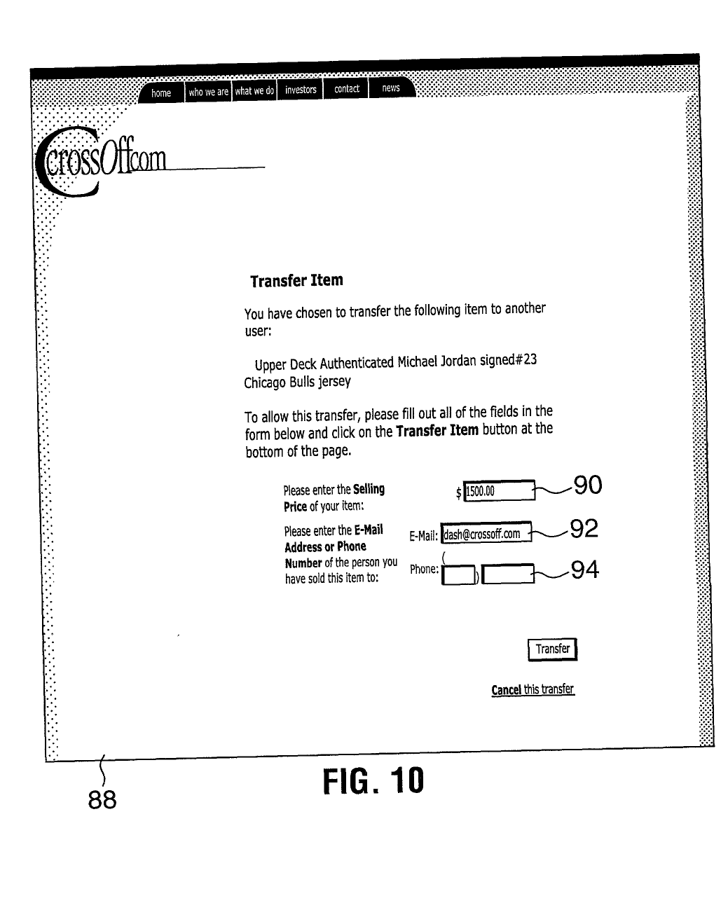

FIG. 10 illustrates a transfer field 88 where the item of FIG. 9, or any other item that is registered with the system may be a transfer in title from one owner to another. On page 88 there is included a selling price field 90 where the selling price is indicated together with an email address field 92 indicating the e-mail address of the buyer. This information is important in order to have the registration company forward the new registration number (not shown) to the buyer which is confidentially forwarded to the buyer and is not known to the current owner making the sale to the new buyer. There is also provided a telephone field 94 for entry of the telephone number of the new buyer.

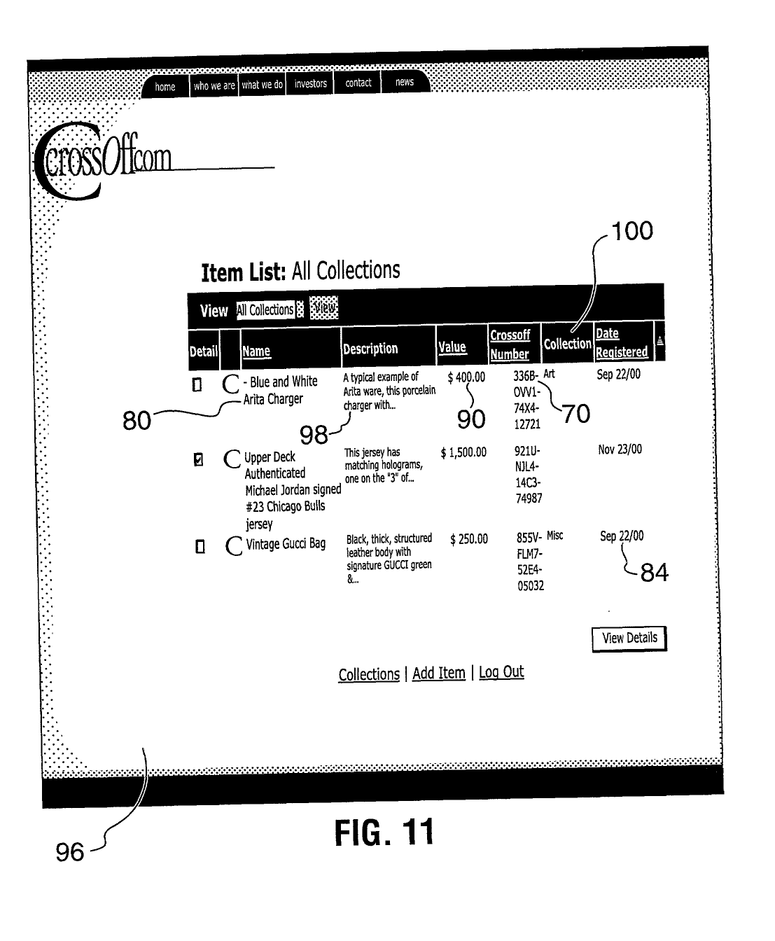

FIG. 11 provides a further page 96 where an owner of articles registered with the registration company may list all of its items in its collection. This page contains a name field 80 for naming the article description field 98 for providing a description of the article named, a value field 90 indicating the value of the article, a registration number field 70 indicated the registration number of the article, a collection field 100 for indicating the type of collection to which the item relates and a date registered field 84 for indicating the date of the registration of the article into the registration company's system.

In summary, various embodiments of the present invention permit product registration with a registration company who generates a certificate of authenticity associated with a product. The certificate has at least two numerical distinctions where one of the numbers is a company registration number visible as a serial number on the product and a hidden number which acts as a unique “password” for the product. Both of these numbers are retained in the database of the registration company. In practice, the consumer purchases an article and receives an article of authenticity that confirms that the object/product/article purchases is not an imitation or forgery and subsequently can confirm the validity of the product by accessing the company registration database via the internet. If the serial number is not the same as that in the registration company's database, the product is deemed to be a forgery. In the event that the serial number is located in the company registration database, the purchaser can then register as the new owner of the item. The registration preserves the integrity of ownership by changing the registration number for the article. This new registration number then becomes useful for reregistration.

Upon subsequent transfers of title of the article, the current owner simply conveys the item code associated with the article to the new owner. The new owner then registers the product with the company registration database as the new owner and the original certificate of authenticity is forwarded to the newly registered owner.

It will be understood that the serial number, item code, etc. may be any useful means of identification including, but not limited to numerals, letters, symbols or any combination thereof.

By providing a protocol as set forth herein together with a system for instituting the protocol, many of the problems outlined in the discussion of the prior art can be alleviated and royalties or residual payments can be collected by rightful owners and consumers protected by actually obtaining what they have paid for.

Although embodiments of the invention have been described above, it is not limited thereto and it will be apparent to those skilled in the art that numerous modifications form part of the present invention insofar as they do not depart from the spirit, nature and scope of the claimed and described invention.

We claim:

1. An online method of confirming authenticity of a purchased good, comprising the steps of:
providing a record of authenticity with a good, said record of authenticity having authenticity data including an item code and an initial registration number unique to said good;
providing an internet accessible database having stored authenticity data for said good;
purchasing said good;
accessing said internet database;
forwarding a subsequent registration number different from said initial registration number;
registering an owner of said good purchased by entering said initial registration number, said subsequent registration number, said item code and purchaser information; and
storing said information in said internet accessible database relative to said good purchased.

2. The method as set forth in claim 1, wherein said registration number is initially concealed on said record of authenticity until revealed by a purchaser.

3. The method as set forth in claim 1, further including a step of providing a serial number with said record of authenticity unique to said good.

4. The method as set forth in claim 3, further including a step of storing said serial number in said database prior to initial purchase of said good.

5. The method as set forth in claim 1, wherein purchaser information at least includes purchaser name, purchase price, and address of said purchaser.

6. The method as set forth in claim 1, further including a step of supplying a manufacturer of said good with said record of authenticity to be included with said good prior to purchase by a purchaser.

7. The method as set forth in claim 1, wherein said database stores all authenticity data for all registered goods.

8. The method as set forth in claim 1, further including a step of transferring ownership of said good purchased, comprising:
providing a buyer with said record of authenticity from said purchaser;
providing said buyer with said item code from said purchaser;
entering said registration number and said item code into said database;
providing said buyer with a different registration number from said registration number of said purchaser;
registering said buyer as an owner by entering said different registration number and said serial number in said database.

9. The method as set forth in claim 8, wherein said different registration number is unknown to said purchaser.

10. The method as set forth in claim 8, wherein said step of entering includes accessing said database by said buyer.

11. The method as set forth in claim 8, wherein said step of providing said buyer with a different registration number includes forwarding said number by electronic means.

12. The method as set forth in claim 11, wherein said electronic means comprises at least one of encrypted electronic mail, telephone and facsimile.

13. The method as set forth in claim 11, wherein said step of providing said buyer with a different registration number comprises mailing said registration number.

14. A method for ensuring authenticity of an article purchased over the internet, comprising the steps of:
providing a website having a database where articles are registered by an owner;
providing a record of authenticity with said article to be registered, said record of authenticity having a registration number and an item number;
entering said registration number and said item number in said database relative to said article;
purchasing by a purchaser, said article and receiving said registration number and said item number;
accessing said database;
providing purchaser registration information to said database;
confidentially receiving a buyer registration number different from said purchaser registration number from said database; and
registering as a new owner of said article.

15. The method as set forth in claim 14, further including the step of confirming authenticity of a purchased article by comparison of owner information in said database relative to that provided when said serial number is entered into said database.

16. The method as set forth in claim 14, wherein said article comprises art work, jewelry, automobiles, musical recordings, clothing, documents and machinery.

17. A method for providing an author/creator with compensation for its commodity having originality value from purchases and transfer of ownership of said commodity over the internet, comprising the steps of:
providing a record of authenticity with a commodity, said record of authenticity having authenticity data including a registration number and item code unique to said commodity;
providing an internet accessible database having stored authenticity data for said commodity;
purchasing said commodity;
accessing said internet database;
registering an owner of said commodity purchased by entering said registration number, said item code and purchaser information;
providing said author/creator with a predetermined percentage of a purchase price of said commodity;
transferring ownership of said commodity to a subsequent purchaser;
providing said subsequent purchaser with said item code;
accessing said database and entering said item code;
confidentially forwarding a subsequent registration number different from said registration number;
registering said subsequent purchaser as a new owner of said commodity; and
providing said author/creator with a second predetermined percentage of said purchase price paid by said subsequent purchaser.

18. An online system for confirming authenticity of a good purchased on the internet, comprising:
means for identifying a good as an original;
computer database means containing said means for identifying an article as an original;
an internet computer network linking potential purchaser computers with each other and said computer database means;
means for registering purchaser information for a purchased good;
means for confirming ownership of a purchased good to a registered purchaser; and
means for confirming authenticity of a subsequently sold article from said purchaser to a new purchaser.

19. The system as set forth in claim 18, further including means for providing an originating author/creator with a predetermined quantity of compensation for each transaction.

20. The system as set forth in claim 18, further including means for forwarding fraudulent article details to at least one of said author/originator, law enforcement, manufacturer or distributor.

21. The system as set forth in claim 18, further including means for registering in said database a collection of authentic items of an owner.

22. A website for registering and confirming authenticity of an article, comprising:
means for confirming an article for registration as an authentic article;
means for registering an article;
means for registering a user;
means for registering an article with an owner;
means for registering an article description;
means for registering transfer of said article from an owner to a purchaser; and
means for registering said purchaser as a new owner of said authentic article.
